(19) United States
(12) Patent Application Publication
(10) Pub. No.: US 2021/0323434 A1
(43) Pub. Date: Oct. 21, 2021

(54) WIRELESS POWER TRANSFER APPARATUS, WIRELESS POWER TRANSFER SYSTEM OF VEHICLE, AND CONTROL METHOD THEREOF

(71) Applicants: Hyundai Motor Company, Seoul (KR); Kia Motors Corporation, Seoul (KR)

(72) Inventors: Kyungsu KIM, Asan-si (KR); Young Chan BYUN, Hwaseong-si (KR); JinGeun BAE, Daegu (KR); Gibum KIM, Pohang-so (KR); Hyeonjun KIM, Siheung-si (KR); Ki Bum LA, Seoul (KR)

(73) Assignees: Hyundai Motor Company, Seoul (KR); Kia Motors Corporation, Sseoul (KR)

(21) Appl. No.: 17/071,537

(22) Filed: Oct. 15, 2020

(30) Foreign Application Priority Data
Apr. 21, 2020 (KR) 10-2020-0047898

(51) Int. Cl. B60L 53/66; H02J 7/04; H02J 50/10; B60L 53/122

(52) U.S. Cl. CPC B60L 53/66; H02J 7/04; H02J 7/007192; B60L 53/122; H02J 50/10

(57) ABSTRACT

A wireless power transfer apparatus may include a charging controller configured of generating a current instruction and a voltage instruction for wireless power transfer, a first circuit portion connected to the charging controller and an external power source and configured of converting an electric power supplied from the external power source to corresponding voltage value and corresponding current value according to the voltage instruction and the current instruction, and a primary coil connected to the first circuit portion and configured of generating an induced current in a secondary coil of an electric vehicle to deliver the electric power converted by the first circuit portion to the electric vehicle, wherein the charging controller estimates temperature of the secondary coil by use of the current value applied to the primary coil, and changes the current instruction for determining a current value applied to the primary coil, according to the estimated temperature of the secondary coil.

### CROSS-REFERENCE TO RELATED APPLICATION

The present application claims priority to Korean Patent Application No. 10-2020-0047898, the entire contents of which is incorporated herein for all purposes by this reference.

### BACKGROUND OF THE INVENTION

### Field of the Invention

The present invention relates to a wireless power transfer apparatus, a wireless power transfer system of vehicle, and a control method thereof.

### Description of Related Art

As one way to solve the air pollution problem, vehicle manufacturers are interested in electric vehicles with little exhaust gas and are focusing on electric vehicles such as expanding investment in technology development and launching a dedicated brand. Furthermore, the governments of many countries are expanding the support for electric vehicles, and the interest of the electric vehicles is increasing as the public's interest is increasing.

The electric vehicle includes an electric motor that replaces an engine of a general vehicle, and a battery that supplies electricity to the electric motor. The battery is charged periodically, and it may be charged, for example, by a plug-in scheme that connects a charging cable directly to the electric vehicle, or by a wireless power transfer scheme that utilizes a magnetic induction phenomenon generated by the primary coil and secondary coil. Meanwhile, the plug-in scheme has an inconvenience of having to plug in an electric vehicle outlet every time it is required to be charged, and the wireless power transfer scheme has recently been expanded.

Meanwhile, in a wireless power transfer (WPT) system for wireless power transfer of electric vehicles, an output electric power is increased to reduce charging time. Therefore, a high current flows from a primary coil of a charging pad of a charging system to a secondary coil of the electric vehicle for a long time, increasing the risk of fire due to heat generation of the coil.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a wireless power transfer apparatus which may include a charging controller configured of generating a current instruction and a voltage instruction for wireless power transfer, a first circuit portion connected to the charging controller and an external power source and configured of converting an electric power supplied from the external power source to corresponding voltage value and corresponding current value according to the voltage instruction and the current instruction, and a primary coil connected to the first circuit portion and configured of generating an induced current in a secondary coil of an electric vehicle to deliver the electric power converted by the first circuit portion to the electric vehicle, wherein the charging controller estimates temperature of the secondary coil by use of the current value applied to the primary coil, and changes the current instruction for determining a current value applied to the primary coil, according to the estimated temperature of the secondary coil.

The charging controller may change the current instruction to lower the current value applied to the primary coil when the estimated temperature of the secondary coil is above a threshold temperature.

The charging controller may be configured to set a temperature estimation model according to a wireless power transfer time and the current value and the voltage value applied to the primary coil, and to estimate the temperature of the secondary coil by applying the wireless power transfer time and the current value applied to the primary coil to the temperature estimation model.

The temperature estimation model may estimate the temperature of the secondary coil higher as the current value applied to the primary coil increases.

The temperature estimation model may estimate the temperature of the secondary coil higher as the wireless power transfer time increases.

The temperature estimation model may be set as a multiplication of a linear function for the wireless power transfer time and a quadratic function for the current value applied to the primary coil.

The charging controller may be configured to set a temperature estimation model according to a wireless power transfer time and the current value and the voltage value applied to the primary coil, the temperature estimation model being respectively set for voltage values, and to estimate the temperature of the secondary coil in real time by applying the wireless power transfer time and the current value according to the voltage value applied to the primary coil to the temperature estimation model.

An exemplary wireless power transfer system may include a secondary coil that receives an electric power from a primary coil of a wireless power transfer apparatus due to generation of an induced current according to a change in the magnetic field, a circuit portion configured of charging a battery by converting the electric power applied to the secondary coil, and a vehicle controller connected to the secondary coil and the circuit portion and configured to receive information indicating a current value applied to the primary coil through a vehicle communication portion, to estimate a temperature of the secondary coil by use of the current value of the received information, and to request a change of the current value applied to the primary coil to the wireless power transfer apparatus through the vehicle communication portion, according to the estimated temperature of the secondary coil.

The vehicle controller may request the wireless power transfer apparatus to lower the current value applied to the primary coil, when the estimated temperature of the secondary coil is above a threshold temperature.

The vehicle controller may be configured to receive information indicating the current value and a voltage value applied to the primary coil from the wireless power transfer apparatus, to set a temperature estimation model according to a wireless power transfer time and the received voltage value and the received current value, and to estimate the temperature of the secondary coil in real time by applying the wireless power transfer time and the received current value to the temperature estimation model.

The temperature estimation model may estimate the temperature of the secondary coil higher as the current value applied to the primary coil increases.

The temperature estimation model may estimate the temperature of the secondary coil higher as the wireless power transfer time increases.

The temperature estimation model may be set taking a parameter of a quadratic function for the current value applied to the primary coil.

The temperature estimation model may be set as a multiplication of a linear function for the wireless power transfer time and a quadratic function for the current value applied to the primary coil.

An exemplary wireless power transfer method may include determining a current instruction and a voltage instruction to prepare wireless power transfer, converting an electric power supplied from an external power source to corresponding voltage value and corresponding current value according to the voltage instruction and the current instruction, delivering the converted electric power to an electric vehicle through a primary coil that generates an induced current to a secondary coil of the electric vehicle, estimating a temperature of the secondary coil by use of the current value applied to the primary coil, determining whether the estimated temperature of the secondary coil is above a threshold temperature, and changing the current instruction for determining the current value applied to the primary coil, based on the determining of whether the estimated temperature of the secondary coil is above a threshold temperature.

The changing of the current instruction may change the current instruction to lower the current value applied to the primary coil when the estimated temperature of the secondary coil is above the threshold temperature.

The estimating of a temperature of the secondary coil may include setting a temperature estimation model according to a wireless power transfer time as well as a current value and a voltage value applied to the primary coil, and estimating the temperature of the secondary coil in real time by applying the wireless power transfer time and the current value applied to the primary coil to the temperature estimation model.

The estimating of the temperature of the secondary coil in real time may estimate the temperature of the secondary coil higher as the current value applied to the primary coil increases or as the wireless power transfer time increases.

According to various exemplary embodiments of the present invention, a temperature of a vehicle-side coil according to a wireless power transfer time is estimated, and a charger-side current is controlled according to the estimated temperature of a vehicle-side coil. Therefore, the vehicle-side coil is prevented from being overheated, preventing burnout and fire in the wireless power transfer vehicle.

Furthermore, the temperature of a vehicle-side coil is estimated without a separate temperature sensor, and the number of portions required for an electric vehicle may be decreased.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates a wireless power transfer system for a vehicle according to an exemplary embodiment of the present invention.

FIG. 2 is a flowchart showing a wireless power transfer method according to an exemplary embodiment of the present invention.

FIG. 3 is an exemplary graph of experimental data which is the basis for setting a temperature estimation model according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments included in the exemplary embodiment will be described in detail with reference to the accompanying drawings. In the exemplary embodiment, the same or similar components will be denoted by the same or similar reference numerals, and a repeated description thereof will be omitted. Terms “module” and/or “unit” for components used in the following description are used only to easily describe the specification. Therefore, these terms do not have meanings or roles that distinguish them from each other in and of themselves. In describing exemplary embodiments of the exemplary embodiment, when it is determined that a detailed description of the well-known art associated with the present invention may obscure the gist of the present invention, it will be omitted. The accompanying drawings are provided only to allow exemplary embodiments included in the exemplary embodiment to be easily understood and are not to be interpreted as limiting the spirit included in the exemplary embodiment, and it is to be understood that the present invention includes all modifications, equivalents, and substitutions without departing from the scope and spirit of the present invention.

Terms including ordinal numbers such as first, second, and the like will be used only to describe various components, and are not to be interpreted as limiting these components. The terms are only used to differentiate one component from other components.

It is to be understood that when one component is referred to as being “connected” or “coupled” to another component, it may be connected or coupled directly to the other component or may be connected or coupled to the other component with a further component intervening therebetween. Furthermore, it is to be understood that when one component is referred to as being “directly connected” or “directly coupled” to another component, it may be connected or coupled directly to the other component without a further component intervening therebetween.

It will be further understood that terms “comprises” and “have” used in the exemplary embodiment specify the presence of stated features, numerals, steps, operations, components, parts, or combinations thereof, but do not preclude the presence or addition of one or more other features, numerals, steps, operations, components, parts, or combinations thereof.

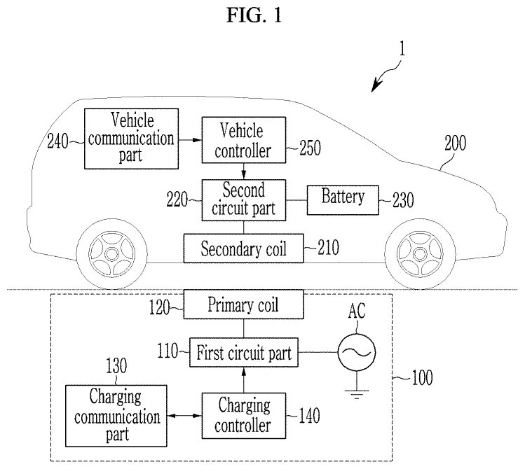

FIG. 1 illustrates a wireless power transfer system for a vehicle according to an exemplary embodiment of the present invention. Referring to FIG. 1, a wireless power transfer system 1 for a vehicle includes a wireless power transfer apparatus 100 and an electric vehicle 200.

The wireless power transfer apparatus 100 includes a first circuit portion 110, a primary coil 120, a charging communication portion 130, and a charging controller 140.

Under a control of the charging controller 140, the first circuit portion 110 converts an electric power supplied from an external power source AC and transmits the converted electric power to the primary coil 120. For example, the first circuit portion 110 converts the electric power supplied from the external power source AC, according to a voltage instruction and a current instruction received from the charging controller 140, and then transmits the converted electric power to the primary coil 120.

The primary coil 120 receives an electric power from the first circuit portion 110 to generate an induced current at the electric vehicle 200. At the instant time, the primary coil 120 recharges the electric vehicle 200 by the electric power supplied from the first circuit portion 110, in a wireless power transfer method using magnetic field. For example, a current value flowing through the primary coil 120 may be changed by switching control of electronic elements and switching elements included in the first circuit portion 110 according to the current instruction received from the charging controller 140.

The charging communication portion 130 may perform wireless communication with the electric vehicle 200 through a network, receiving a wireless power transfer request, or transmitting information indicating a voltage value and a current value applied to the primary coil 120.

The charging controller 140 controls overall wireless power transfer, by generating the current instruction and the voltage instruction for determining the voltage value and the current value applied to the primary coil 120 when charging the electric vehicle 200 with the electric power supplied from the external power source AC. For example, the charging controller 140 may include a temperature estimation model that estimates a temperature of a secondary coil 210 of the electric vehicle 200.

The electric vehicle 200 includes the secondary coil 210, a second circuit portion 220, a battery 230, a vehicle communication portion 240, and a vehicle controller 250.

The secondary coil 210 receives AC power from the wireless power transfer apparatus 100 due to a change in the magnetic field by the primary coil 120.

The second circuit portion 220 converts the AC power applied from the secondary coil 210 to DC power under the control of the vehicle controller 250, and boosts or lowers the converted DC power to charge the battery 230 of a high voltage. For example, the second circuit portion 220 may include an on-board charger (OBC).

The battery 230 supplies an electrical energy to a motor by discharging for driving of the electric vehicle 200, and is recharged by the electric power supplied from the second circuit portion 220.

The vehicle communication portion 240 may perform wireless communication with the wireless power transfer apparatus 100 through a network, transmitting a wireless power transfer request, or requesting information indicating the voltage value and the current value applied to the primary coil 120 to estimate a temperature of the secondary coil 210.

The vehicle controller 250 controls the second circuit portion 220 to recharge the battery 230 by the electric power supplied from the wireless power transfer apparatus 100. For example, the vehicle controller 250 may include the temperature estimation model that estimates the temperature of the secondary coil 210.

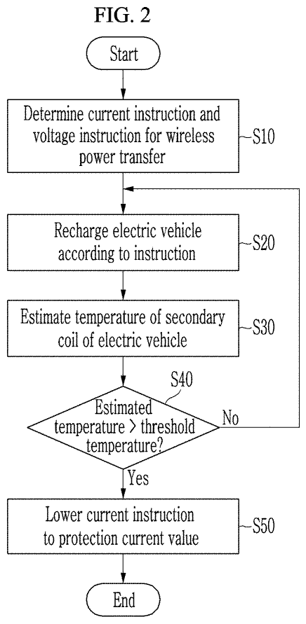

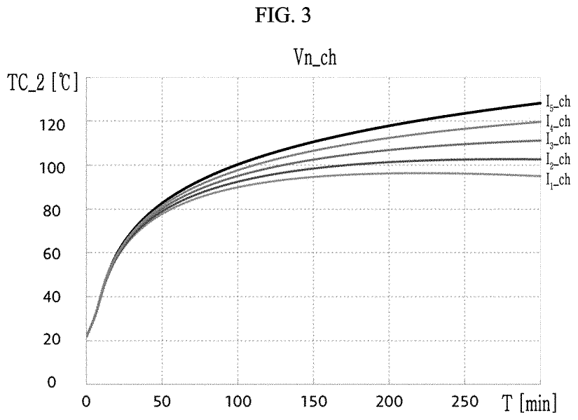

FIG. 2 is a flowchart showing a wireless power transfer method according to an exemplary embodiment of the present invention. FIG. 3 is an exemplary graph of experimental data which is the basis for setting a temperature estimation model according to an exemplary embodiment of the present invention.

Referring to FIG. 1 to FIG. 3, a wireless power transfer apparatus, a wireless power transfer system for a vehicle, and wireless power transfer method are hereinafter described in detail.

According to various exemplary embodiments of the present invention, the wireless power transfer apparatus 100 includes the temperature estimation model, and may estimate the temperature of the secondary coil 210 of the electric vehicle 200 in real time. According to another exemplary embodiment of the present invention, the electric vehicle 200 includes the temperature estimation model, and may estimate the temperature of the secondary coil 210 in real time. Hereinafter, at least one of the wireless power transfer apparatus 100 and the electric vehicle 200 includes the temperature estimation model, and may estimate the temperature of the secondary coil 210 in real time based on a wireless power transfer time and the current value and the voltage value applied to the primary coil 120.

Firstly at step S10, the charging controller 140 prepares wireless power transfer by generating a current instruction and a voltage instruction according to a wireless power transfer request received from the electric vehicle 200 through the charging communication portion 130. At the instant time, the charging controller 140 may select a current instruction and a voltage instruction from among a plurality of predetermined current instructions and predetermined voltage instructions, accounting for a state of the wireless power transfer apparatus 100 and a state of the electric vehicle 200.

According to another exemplary embodiment of the present invention, the vehicle controller 250 may transmit a wireless power transfer request to the wireless power transfer apparatus 100 through the vehicle communication portion 240, and may receive a power transfer initiation message in a response to the wireless power transfer request. At the instant time, upon receiving the wireless power transfer request from the electric vehicle 200 through the charging communication portion 130, the charging controller 140 generates the current instruction and the voltage instruction according to the wireless power transfer request to prepare the wireless power transfer.

Subsequently at step S20, the charging controller 140 charges the electric vehicle 200 with electric power applied from the external power source AC.

In more detail, the charging controller 140 transmits the current instruction and the voltage instruction to the first circuit portion 110 to convert the electric power applied from the external power source AC. The electric power converted through the first circuit portion 110 charges the electric vehicle 200 through the primary coil 120.

The current and voltage applied to the primary coil 120 is changed in a response to the current instruction and the voltage instruction delivered to the first circuit portion 110. When the magnetic field induced by the primary coil 120 changes as a result, the amount of current induced in the secondary coil 210 of the electric vehicle 200 also changes according to electromagnetic induction.

Subsequently at step S30, the charging controller 140 estimates the temperature of the secondary coil 210 in real time by use of the current value according to the voltage value applied to the primary coil 120. Then at step S40, the charging controller 140 determines whether the estimated temperature of the secondary coil 210 is above a threshold temperature.

The charging controller 140 may set the temperature estimation model that estimates the temperature of the secondary coil 210, according to the wireless power transfer time and the current value and the voltage value applied to the primary coil 120. At the instant time, the charging controller 140 may set the temperature estimation model by deriving a correlation equation between the wireless power transfer time and the current value applied to the primary coil 120, for voltage values applied to the primary coil 120 based on experimental data.

Referring to FIG. 3, a temperature TC_2 of the secondary coil 210 increases as the current value In_ch applied to the primary coil 120 increases or the wireless power transfer time T increases. At the instant time, the current value increases in the order of I1_ch, I2_ch, I3_ch, I4_ch, and I5_ch.

When the voltage value Vn_ch applied to the primary coil 120 is 400V, the charging controller 140 may drive the following equation 1 as a correlation equation based on the experimental data of FIG. 3 showing the correlation between the wireless power transfer time T and a plurality of current values, for example, I1_ch of 50A, I2_ch of 100A, I3_ch of 150A, I4_ch of 200A, and I5_ch of 300A, applied to the primary coil 120.

TC_2=(A×T)(B×I_ch²+C×I_ch+D) (Equation 1)

Referring to equation 1, the temperature TC_2 of the secondary coil 210 may be derived by a correlation equation which is set as a multiplication of a linear function for the wireless power transfer time T and a quadratic function for the current value I_ch applied to the primary coil 120.

TABLE 1
Vn_ch

| I_ch[A] | A | B | C | D |
|---|---|---|---|---|
| 0 | a1 | b1 | c1 | d1 |

| | | | | | |
|---|---|---|---|---|---|
| 50 | A | a2 | b2 | c2 | d2 |
| 100 | A | a3 | b3 | c3 | d3 |
| 150 | A | a4 | b4 | c4 | d4 |
| 200 | A | a5 | b5 | c5 | d5 |
| 250 | A | a6 | b6 | c6 | d6 |

Referring to table 1, the constants A, B, C, and D included in the equation 1 with respect to each of the current values I_ch, e.g., 50A, 100A, 150A, 200A, and 250A, applied to the primary coil 120 may be determined based on the experimental data of FIG. 3. The temperature estimation model based on the equation 1 and the table 1 estimates the temperature TC_2 of the secondary coil 210 higher as the current value I_ch applied to the primary coil 120 increases. Furthermore, the temperature estimation model is configured for estimating the temperature TC_2 of the secondary coil 210 higher as the wireless power transfer time T increases.

Based on the equation 1 and the table 1, the charging controller 140 may set the temperature estimation model that estimates the temperature TC_2 of the secondary coil 210.

Accordingly, the charging controller 140 may apply the wireless power transfer time T and the current value I_ch applied to the primary coil 120 to the temperature estimation model, to estimate the temperature TC_2 of the secondary coil 210 in real time. Referring to FIG. 3, the charging controller 140 may estimate the temperature TC_2 of the secondary coil 210 higher as the current value I_ch applied to the primary coil 120 increases or as the wireless power transfer time T increases.

According to another exemplary embodiment of the present invention, the vehicle controller 250 may also set the temperature estimation model that estimates the temperature TC_2 of the secondary coil 210, based on the equation 1 and the table 1. The vehicle controller 250 may receive information indicating the voltage value V_ch and the current value I_ch applied to the primary coil 120 through the vehicle communication portion 240, and estimate the temperature TC_2 of the secondary coil 210 in real time by applying the received the current value I_ch and the wireless power transfer time T according to the received the voltage value V_ch and to the temperature estimation model.

Subsequently at step S40, the charging controller 140 determines whether the estimated temperature TC_2 of the secondary coil 210 is above the threshold temperature. When the estimated temperature TC_2 of the secondary coil 210 is above the threshold temperature (S40-Yes), the charging controller 140 changes, at step S50, the current instruction such that the current value I_ch applied to the primary coil 120 is lowered to a protection current value.

According to another exemplary embodiment of the present invention, at the step S40, the vehicle controller 250 may determine whether the estimated temperature TC_2 of the secondary coil 210 is above the threshold temperature. When the estimated temperature TC_2 of the secondary coil 210 is above the threshold temperature (S40-Yes), the vehicle controller 250 may send a request to the wireless power transfer apparatus 100 through the vehicle communication portion 240 at the step S50 such that the current value I_ch applied to the primary coil 120 is lowered to the protection current value.

Furthermore, the term “controller” or “control unit” refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The controller according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors.

The controller or the control unit may be at least one microprocessor operated by a predetermined program which may include a series of commands for carrying out a method in accordance with various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A wireless power transfer apparatus comprising:
a charging controller configured of generating a current instruction and a voltage instruction for wireless power transfer;
a first circuit portion connected to the charging controller and an external power source and configured of converting an electric power supplied from the external power source to corresponding voltage value and corresponding current value according to the voltage instruction and the current instruction; and
a primary coil connected to the first circuit portion and configured of generating an induced current in a secondary coil of an electric vehicle to deliver the electric power converted by the first circuit portion to the electric vehicle,
wherein the charging controller is configured to estimate a temperature of the secondary coil by use of the current value applied to the primary coil, and to change the current instruction for determining a current value applied to the primary coil, according to the estimated temperature of the secondary coil.

2. The wireless power transfer apparatus of claim 1, wherein the charging controller is configured to change the current instruction to lower the current value applied to the primary coil when the estimated temperature of the secondary coil is above a threshold temperature.

3. The wireless power transfer apparatus of claim 1, wherein the charging controller is configured to:
set a temperature estimation model according to a wireless power transfer time and the current value and the voltage value applied to the primary coil; and
estimate the temperature of the secondary coil by applying the wireless power transfer time and the current value applied to the primary coil to the temperature estimation model.

4. The wireless power transfer apparatus of claim 3, wherein the temperature estimation model is configured for estimating the temperature of the secondary coil higher as the current value applied to the primary coil increases.

5. The wireless power transfer apparatus of claim 3, wherein the temperature estimation model is configured for estimating the temperature of the secondary coil higher as the wireless power transfer time increases.

6. The wireless power transfer apparatus of claim 3, wherein the temperature estimation model is set as a multiplication of a linear function for the wireless power transfer time and a quadratic function for the current value applied to the primary coil.

7. The wireless power transfer apparatus of claim 1, wherein the charging controller is configured to:
set a temperature estimation model according to a wireless power transfer time and the current value and the voltage value applied to the primary coil, the temperature estimation model being respectively set for voltage values; and
estimate the temperature of the secondary coil in a real time by applying the wireless power transfer time and the current value according to the voltage value applied to the primary coil to the temperature estimation model.

8. A wireless power transfer system comprising:
a secondary coil that receives an electric power from a primary coil of a wireless power transfer apparatus due to generation of an induced current according to a change in the magnetic field;
a circuit portion configured of charging a battery by converting the electric power applied to the secondary coil; and
a vehicle controller connected to the secondary coil and the circuit portion and configured to receive information indicating a current value applied to the primary coil through a vehicle communication portion, to estimate a temperature of the secondary coil by use of the current value of the received information, and to request a change of the current value applied to the primary coil of the wireless power transfer apparatus through the vehicle communication portion, according to the estimated temperature of the secondary coil.

9. The wireless power transfer system of claim 8, wherein the vehicle controller is configured to request the wireless power transfer apparatus to lower the current value applied to the primary coil, when the estimated temperature of the secondary coil is above a threshold temperature.

10. The wireless power transfer system of claim 9, wherein the vehicle controller is configured to:
receive information indicating the current value and a voltage value applied to the primary coil from the wireless power transfer apparatus;
set a temperature estimation model according to a wireless power transfer time and the received voltage value and the received current value; and
estimate the temperature of the secondary coil in a real time by applying the wireless power transfer time and the received current value to the temperature estimation model.

11. The wireless power transfer system of claim 10, wherein the temperature estimation model is configured for estimating the temperature of the secondary coil higher as the current value applied to the primary coil increases.

12. The wireless power transfer system of claim 11, wherein the temperature estimation model is configured for estimating the temperature of the secondary coil higher as the wireless power transfer time increases.

13. The wireless power transfer system of claim 12, wherein the temperature estimation model is set taking a parameter of a quadratic function for the current value applied to the primary coil.

14. The wireless power transfer system of claim 13, wherein the temperature estimation model is set as a multiplication of a linear function for the wireless power transfer time and a quadratic function for the current value applied to the primary coil.

15. A wireless power transfer method comprising:
determining a current instruction and a voltage instruction to prepare wireless power transfer;
converting an electric power supplied from an external power source to corresponding voltage value and corresponding current value according to the voltage instruction and the current instruction;
delivering the converted electric power to an electric vehicle through a primary coil that generates an induced current to a secondary coil of the electric vehicle;
estimating a temperature of the secondary coil by use of the current value applied to the primary coil;
determining whether the estimated temperature of the secondary coil is above a threshold temperature; and
changing the current instruction for determining the current value applied to the primary coil, according to the determining of whether the estimated temperature of the secondary coil is above a threshold temperature.

16. The wireless power transfer method of claim 15, wherein the changing of the current instruction includes changing the current instruction to lower the current value applied to the primary coil when the estimated temperature of the secondary coil is above the threshold temperature.

17. The wireless power transfer method of claim 16, wherein the estimating of a temperature of the secondary coil includes:
setting a temperature estimation model according to a wireless power transfer time as well as a current value and a voltage value applied to the primary coil; and
estimating the temperature of the secondary coil in a real time by applying the wireless power transfer time and the current value applied to the primary coil to the temperature estimation model.

18. The wireless power transfer method of claim 17, wherein the estimating of the temperature of the secondary coil in a real time includes estimating the temperature of the secondary coil higher as the current value applied to the primary coil increases or as the wireless power transfer time increases.
